(19) United States
(12) Patent Application Publication
(10) Pub. No.: US 2021/0353017 A1
(43) Pub. Date: Nov. 18, 2021

(54) Pet Treat Bag

(71) Applicant: Taly Georgia Matiteyahu, Los Angeles, CA (US)

(72) Inventor: Taly Georgia Matiteyahu, Los Angeles, CA (US)

(21) Appl. No.: 17/302,546

(22) Filed: May 5, 2021

Related U.S. Application Data
(60) Provisional application No. 62/704,585, filed on May 16, 2020.

(51) Int. Cl. A45C 7/00; A01K 27/00; A45F 5/02; B65D 33/16

(52) U.S. Cl. CPC A45C 7/0059; A01K 27/008; A45F 2200/05; B65D 33/16; A45F 2005/023; A45F 5/02

(57) ABSTRACT

The present invention provides pet handlers with a bag designed to allow easy transport of and access to pet treats. The pet treat bag is comprised of (1) the main body to hold the treats, (2) a cover that closes the bag tightly using a mechanism that can be opened using one hand, and (3) a means for easily attaching the bag to external objects, including but not limited to, leashes, belt loops, purses, backpacks, and more.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of Invention

The present invention relates to a bag designed to hold pet treats and allow pet caretakers easy access to treats. The bag is lightweight, convenient, easy to open, and easy to clean.

### 2. Description of the Related Art

Existing treat carriers are large, bulky, and difficult to access while also managing sometimes unruly pets. They are often too large to attach to a pet's leash and need to be attached to one's waistband. Smaller treat carriers have drawstring closure mechanisms, making it impossible to access the contents of the carrier using only one hand.

Given the current market, treat bags that are lightweight, convenient to carry, easy to open, and easy to clean are not yet available.

### BRIEF SUMMARY OF THE INVENTION

A main object of the present invention is to provide pet owners with a pet treat bag that is easy to carry, open, and use to access treats. The pet treat bag of the present invention comprises a bag body with a space for treats to be stored and carried, along with a cover that seals the bag and prevents treats from falling out while also being easy to open. Another object of the present invention is to provide a pet treat bag that is easy to open using one hand.

Another object of the present invention is to provide a pet treat bag where the attachment mechanism can be easily attached to a desired object.

Another object of the present invention is to provide a pet treat bag where the bag's body holds its form regardless of the number of treats within it.

Another object of the present invention is to provide a pet treat bag where the bag body has an elastic element that allows the bag to expand and contract to fit a varied number of treats.

Accordingly, in order to accomplish the above objects, the present invention provides a pet treat bag, comprising:

a bag body having a front side, back side, and two side walls with a cavity to store pet treats and a top opening to access the treats;

a bag cover that reaches from the back of the bag body over the front of the bag body; an attachment device that allows the bag to be attached to desired objects.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a perspective view of the pet treat bag in a fully closed state from the side, according to the preferred embodiment of the present invention.

FIG. 2 is a perspective view of the pet treat bag in a fully closed state from the front, according to the preferred embodiment of the present invention.

FIG. 3 is a perspective view of the pet treat bag in an open state from the side, according to the preferred embodiment of the present invention.

FIG. 4 is a perspective view of the pet treat bag in an open state from the front, according to the preferred embodiment of the present invention.

### DETAILED DESCRIPTION OF THE INVENTION

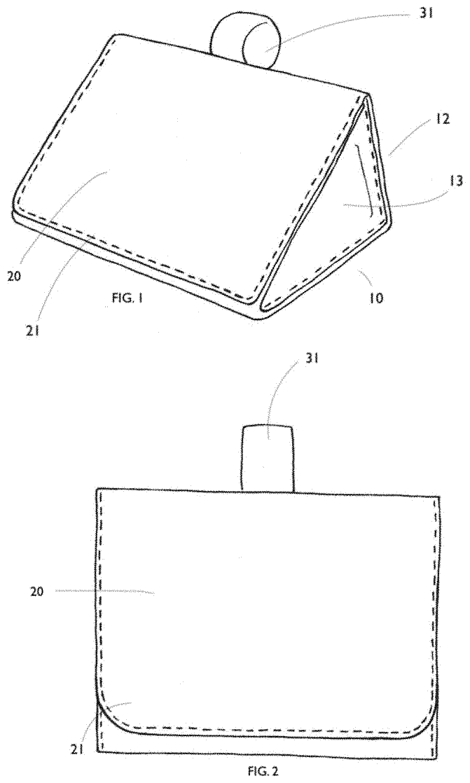

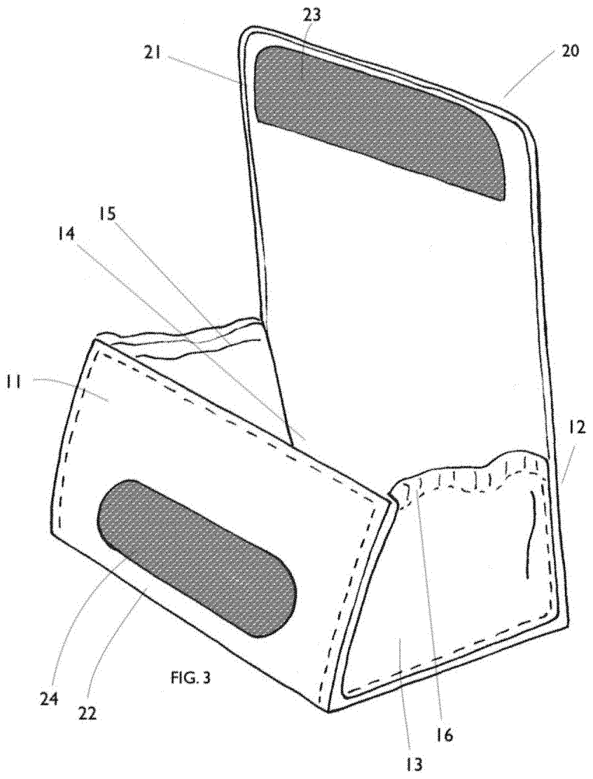

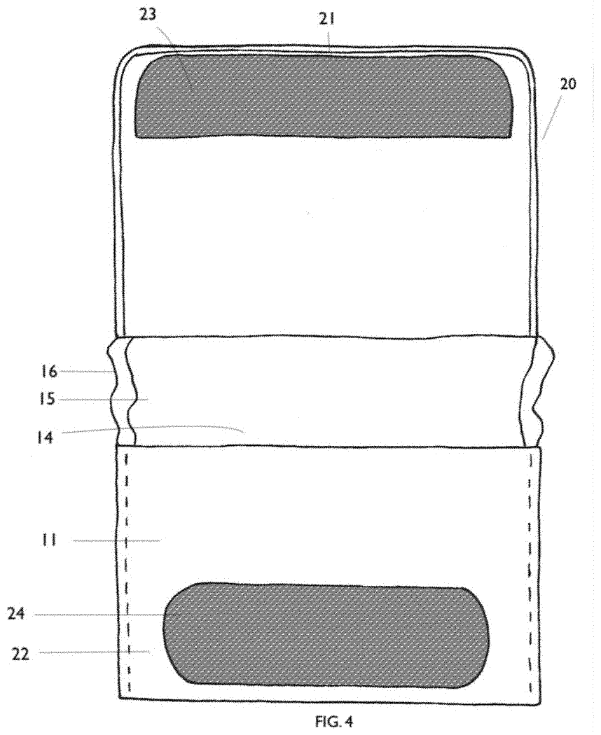

Referring to FIGS. 1-4 of the drawings, a pet treat bag according to a preferred embodiment of the present invention is illustrated, wherein the pet treat bag comprises of a bag body 10, a closure flap 20, an attachment loop 31, a closure flap closing mechanism 23 on the closure flap edge 21, and a front closure mechanism 24 on the front bottom edge 22.

The pet treat bag has a front side 11, back side 12, and two sidewalls 13, defining a treat space 14 to store pet treats therein, as well as a top opening 15 to enable users to fill the treat space 14 with treats. According to the preferred embodiment of the present invention, the pet treat bag is designed in such a way that treats can be easily accessed through the top opening 15.

To ensure the bag opening 15 remains closed and prevent treats stored within the treat space 14 from falling out, the pet treat bag has a closure flap 20 which extends from the back side 12 and is frontwardly folded to cover the top opening 15 of the bag body 10 so as to enclose the treat space 14. The closure flap 20 has a closure flap mechanism 23 that extends along the closure flap edge 21, which can attach and detach from the front closure mechanism 24, which extends along the front cover edge 22 on the front side 11 of the bag body 10.

According to the preferred embodiment of the present invention, the closure flap mechanism 23 is on the inner side of the closure flap 20 and the front closure mechanism 24 is on the outer side of the front side 11. The closure flap mechanism 23 and front closure mechanism 24 are arranged to fasten in such a way that the closure flap 20 is retained in a closed position and tightly covers the top opening 15. The closure flap mechanism 23 and front closure mechanism 24 can be other connectors, including magnet, button snap, and other attachable and detachable means. According to the preferred embodiment of the present invention, the closure flap mechanism 23 and front closure mechanism 24 are Velcro.

According to the preferred embodiment of the present invention, to accommodate different treat types and quantities within the treat space 14, the bag body 10 further comprises side elastics 16 within the top edges of the sidewalls 13. The side elastics 16 enable the bag opening 15 to decrease and increase in size to securely retain treats within the treat space 14. The side elastics 16 also pull the front side 11 and the back side 12 towards each other so as to form the treat space 14 in a trapezoid shape. This structure both prevents treats from falling out of the treat space 14 when there are smaller volumes of treats within the treat space 14 as the bag opening 15 shrinks in size while also allowing a larger volume of treats to be stored inside the treat space 14 by expanding the bag opening 15 to accommodate additional volume of treats.

It should be noted that the pet treat bag, including the front side 11, back wall 12, and closure flap 20, have inner linings to ensure the bag body 10 retains its shape even when it does not contain treats and that they have an inner fabric lining that is easy to wipe down to ensure the bag body 10 can be cleaned of treat residue.

According to the preferred embodiment of the present invention, the pet treat bag further has an attachment loop 31 to enable the pet treat bag to be attached to foreign objects and carry it around more easily.

One skilled in the art will understand that the embodiment of the present invention as shown in the drawings and described above is exemplary only and not intended to be limiting

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1) A pet treat bag comprising:
a bag body having a front side, a back side, and two sidewalls defining a treat space to store pet treats therein and a bag opening enabling access to the treat space, wherein said bag body comprises side elastics along the top edges of the sidewalls at said bag opening so as to shrink the size of said bag opening of said bag body for securely retaining treats within said treat space and to substantially pull said front and back sides towards each other so as to form said treat space having a trapezoid shape;
a closure flap, having a front cover edge, extended from said back side of said bag body for covering said bag opening of said treat space, wherein said closure flap is frontwardly folded to cover said bag opening of said bag body so as to enclose said treat space for retaining said pet treats therein, wherein said bag opening of said bag body is shrunk for preventing said treats from falling out of said treat space when said closure flap is unfolded to open up said treat space;
a mechanism that allows attachment and detachment of the closure flap to the front side of the bag body;
an attachment loop for said bag body to be attached to foreign objects and carried.
